(19) United States
(12) Patent Application Publication
(10) Pub. No.: US 2024/0300052 A1
(43) Pub. Date: Sep. 12, 2024

(54) JOINED BODY, LASER MACHINING METHOD AND LASER MACHINING DEVICE

(71) Applicant: Panasonic Intellectual Property Management Co., Ltd., Osaka (JP)

(72) Inventors: MASATO TAYAMOTO, Osaka (JP); YOSHIRO KITAMURA, Osaka (JP); MASAHIRO MORI, Osaka (JP)

(21) Appl. No.: 18/668,288

(22) Filed: May 20, 2024

Related U.S. Application Data
(63) Continuation of application No. PCT/JP2022/028424, filed on Jul. 22, 2022.

(30) Foreign Application Priority Data
Nov. 29, 2021 (JP) 2021-193486

(51) Int. Cl. B23K 26/323; B23K 26/06; B23K 26/064; B23K 26/067; B23K 103/10; B23K 103/12; B23K 103/20; B23K 103/22

(52) U.S. Cl. CPC B23K 26/323; B23K 26/0608; B23K 26/0619; B23K 26/064; B23K 26/0676; B23K 2103/10; B23K 2103/12; B23K 2103/20; B23K 2103/22

(57) ABSTRACT

A laser machining method is a laser machining method for joining a first member containing a first metal and a second member containing a second metal different from the first metal, the method including a first step of forming a joint in which the first metal and the second metal are melted by performing scanning with a first laser beam, and a second step of stirring a metal structure near the joint by performing scanning, on a rear side in a scanning direction of the first laser beam, with a second laser beam having a beam diameter larger than a bean diameter of the first laser beam and having a lower power density than a power density of the first laser beam.

### TECHNICAL FIELD

The present invention relates to a joined body formed by laser welding of overlapping dissimilar metal strip materials, a laser machining method for the joined body, and a laser machining device.

### BACKGROUND ART

In recent years, there is an increasing demand for lap welding of dissimilar metal materials in industry. Main examples thereof include joining of iron and aluminum, joining of iron and copper, and joining of copper and aluminum from the viewpoint of weight reduction of a joined body, electric and thermal conductivity of materials, and the like. However, welding of these members has the following problems unique to the dissimilar metal welding method, and the welding is usually considered to be difficult.

As a conventional joining example of dissimilar metal materials, for example, there is an example of welding of a can and a tab of a battery, in which iron and copper are subjected to laser welding (see, for example, PTL 1). FIG. 12 is a schematic sectional view illustrating a sectional structure of a conventional joining and penetration shape of dissimilar metal materials described in PTL 1. In FIG. 12, can 26 which is an iron material and negative electrode tab 27 which is copper are illustrated. FIG. 12 illustrates molten part 28 where the penetration depth reaches from the iron side to the copper side when the can and the negative electrode tab are subjected to laser welding. FIG. 12 also illustrates re-molten part 29 formed when the concentration of Ni plating present on the surface of the can is adjusted by further irradiating only a surface portion of the can with laser again after molten part 28 is formed.

### CITATION LIST

### Patent Literature

PTL 1: Unexamined Japanese Patent Publication No. 2019-539062

### SUMMARY OF THE INVENTION

When welding of dissimilar metal materials is performed with laser irradiation, for example, in a combination of iron and copper as described above, melting and joining are performed by laser irradiation from the iron or copper side. In this case, there is a problem that solidification cracking due to segregation of copper in the welded portion occurs near a joint due to a difference in material properties such as melting point and thermal conductivity between iron and copper.

The present invention solves the above-described conventional problems, and an object of the present invention is to provide a joining method for suppressing a welding defect in welding of dissimilar metal materials.

A joined body according to the present disclosure includes a first workpiece made of a first metal, a second workpiece made of a second metal different from the first metal, and a joint joining the first workpiece and the second workpiece. The joint includes a first joint located on a side of the first workpiece and a second joint located on a side of the second workpiece, and a concentration of metal contained in the first joint is different from a concentration of metal contained in the second joint.

A laser machining method according to the present disclosure is a laser machining method for joining a first member containing a first metal and a second member containing a second metal different from the first metal, the method including a first step of forming a joint in which the first metal and the second metal are melted by performing scanning with a first laser beam, and a second step of stirring a metal structure near the joint by performing scanning, on a rear side in a scanning direction of the first laser beam, with a second laser beam having a beam diameter larger than a bean diameter of the first laser beam and having a lower power density than a power density of the first laser beam.

A laser machining device according to the present disclosure includes an irradiation optical system that irradiates a workpiece with a first laser beam on a front side along a scanning direction and a second laser beam on a rear side, and a scanning system that scans the workpiece with the first laser beam and the second laser beam along the scanning direction while irradiating the workpiece with the first laser beam and the second laser beam.

In this manner, according to the joined body, the laser machining method, and the laser machining device according to the present disclosure, it is possible to control the composition in the vicinity of the joint in the joined body obtained after laser welding of dissimilar metal materials. This makes it possible to avoid solidification cracking due to segregation of dissimilar metal materials in the molten part of the joint or formation of an intermetallic compound that may cause a decrease in the joint strength of the joined body, and to realize good joining of dissimilar metal materials.

### BRIEF DESCRIPTION OF THE DRAWINGS

FIG. 1 is a schematic perspective view illustrating a configuration of an optical system using a laser oscillator and a two-dimensional diffractive optical element as a branching optical system in a laser machining device according to a first exemplary embodiment.

FIG. 2 is a schematic perspective view illustrating a configuration using a laser oscillator and a branching optical system in a laser machining device according to a first modified example of the first exemplary embodiment.

FIG. 3 is a schematic perspective view illustrating a configuration of an optical system using a laser oscillator and a three-dimensional diffractive optical element as a branching optical system in a laser machining device according to a second modified example of the first exemplary embodiment.

FIG. 4 is a schematic sectional view illustrating the states of a section of a molten part in time series in the order of (a), (b), and (c) when sequential scanning with a first laser beam and a second laser beam is performed in the laser machining method according to the first exemplary embodiment.

FIG. 5 is a plan view illustrating laser diameters and a beam-to-beam distance of the first laser beam and the second laser beam with which a workpiece is irradiated in the laser machining method according to the first exemplary embodiment.

FIG. 6 includes schematic diagrams illustrating the proportion of the Cu element in a section after laser beam scanning divided by the number of laser scans in (a) to (c) in a simulation of laser welding of overlapping members of Fe and Cu in the laser machining method according to the first exemplary embodiment.

FIG. 7 is a schematic view illustrating the states of mixing and stirring of dissimilar metals in the vicinity of a joining interface between workpieces P1, P2 in time series in the laser machining method according to the first exemplary embodiment.

FIG. 8 is a schematic sectional view illustrating a sectional structure when scanning is performed a plurality of times with multi-branched laser according to an exemplary embodiment.

FIG. 9 is an equilibrium state diagram of Fe and Cu.

FIG. 10 is an equilibrium state diagram of Fe and Al.

FIG. 11 is an equilibrium state diagram of Al and Cu.

FIG. 12 is a schematic sectional view illustrating a sectional structure of a molten part formed in lap laser welding of conventional dissimilar metal welding.

### DESCRIPTION OF EMBODIMENT

### (Background to the Present Disclosure)

First, the cause of occurrence of solidification cracking at the time of joining dissimilar metal materials was considered. The cause of occurrence of solidification cracking can be described with the composition ratio of elements as follows from an equilibrium state diagram.

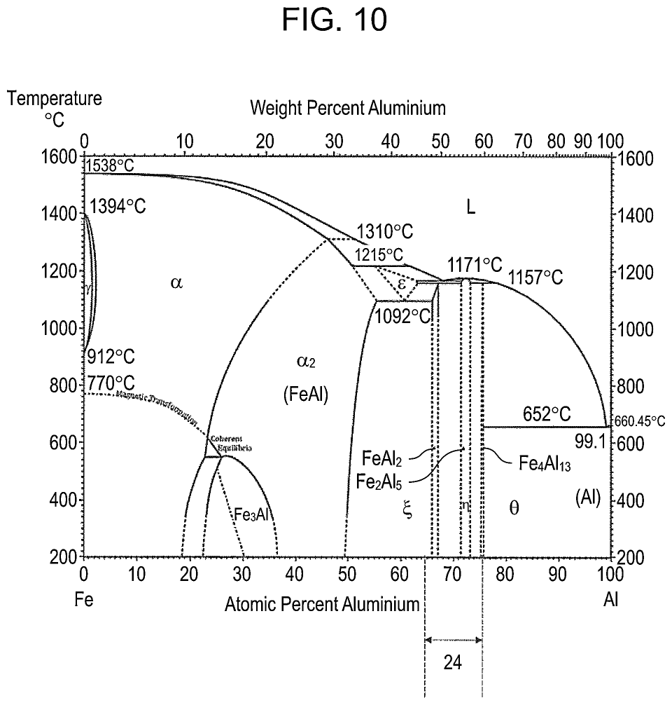

(1) As for the composition of a joint of dissimilar metal joining of iron and copper, a good solid solution is formed when the concentration of copper is within 15 atom % as shown by region 23 in the Fe—Cu equilibrium state diagram illustrated in FIG. 10. However, in a region where the concentration of copper with respect to iron is more than or equal to 15 atom %, a solubility gap occurs, and two-phase separation is likely to occur. In addition, the phase of the solid solution having such two or more types of mixed compositions becomes unstable as the temperature decreases, and a phenomenon called spinodal decomposition occurs in which fluctuation occurs in the mixed compositions and two-phase separation proceeds. It has been reported that copper segregates in a molten part at the time of complete solidification, and solidification cracking occurs due to a difference in mechanical properties between iron and copper.

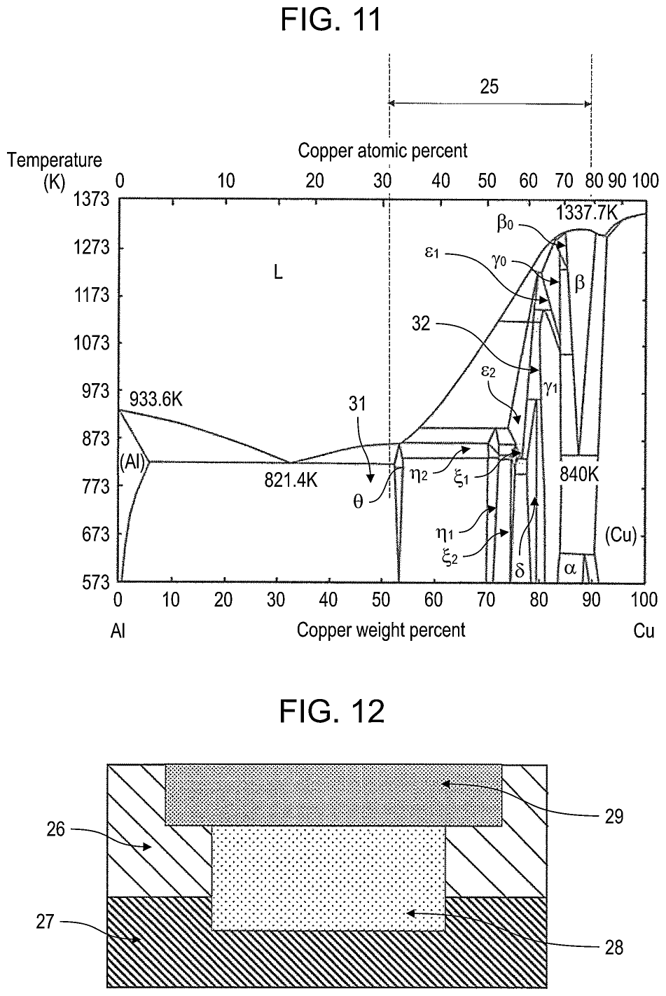

(2) As for the dissimilar metal joining between iron and aluminum, it has been reported that, as shown by region 24 of the equilibrium state diagram illustrated in FIG. 10, in iron and aluminum, the aluminum-rich intermetallic compounds Fe₂Al₅, FeAl₂, and FeAl₃ are formed in the vicinity of the interface of the joint in a region where the concentration of aluminum with respect to iron is more than or equal to 65 atom % and less than or equal to 75 atom %, and the joining strength decreases. It has also been reported that in the dissimilar metal joining between aluminum and copper, as shown by region 25 of the equilibrium state diagram illustrated in FIG. 11, when Al with respect to Cu has a concentration of more than or equal to 30 atom % and less than or equal to 80 atom %, CuAl and CuAl₂ are formed in the vicinity of the interface of the joint, which reduce the joining strength or become a starting point of crack generation.

From the equilibrium state diagrams, it can be seen that these are all defective phenomenona at the time of welding caused by the mixing proportions of dissimilar metals at the time of melting and welding members falling in a specific range with laser irradiation. That is, welding of dissimilar metal materials has a unique problem of occurrence of a phenomenon that causes a solidification cracking defect, a decrease in strength due to formation of an intermetallic compound, and crack generation.

The inventors have focused on the fact that the above-described defect phenomenon frequently occurs in the vicinity of the joint of the metal on the laser irradiation side in the laser welding of dissimilar metal materials. As a result of repeated studies to solve the above-described defect phenomenon, the inventors have found that when scanning and welding is performed on overlapping members made of dissimilar metal materials with branched lasers, a mixed region of dissimilar metals in the vicinity of the joint is widened, and the concentration of each metal is lowered as a whole, thereby completing the present invention.

The present invention relates to lap laser welding on dissimilar metal materials in which two plate-shaped members made of any of iron, copper, and aluminum are combined. In the laser welding according to the present disclosure, using a first laser beam on the front side in a scanning direction and a second laser beam disposed on the rear side in the scanning direction, irradiation and scanning with the first laser beam on the front side, followed by irradiation and scanning with the second laser beam on the rear side, are performed to join the overlapping members. This causes the metal structure in the vicinity of the joint formed by irradiation of the first laser beam to be stirred by irradiation of the second laser beam and causes the concentration of the dissimilar metal materials mixed at the time of welding the members to be reduced, which makes it possible to form a joined body that prevents solidification cracking and formation of an intermetallic compound.

Aspects of the present disclosure will be described below.

A joined body according to a first aspect is a joint body in which a first workpiece made of a first metal and a second workpiece made of a second metal different from the first metal are joined by a joint, wherein the joint includes a first joint located on a side of the first workpiece and a second joint located on a side of the second workpiece, and the first joint and the second joint have different metal concentrations.

In a joined body according to a second aspect, in the first aspect, the first joint may have a thickness larger than a thickness of the second joint in a sectional view in a direction perpendicular to a direction of overlapping of the first workpiece and the second workpiece.

In a joined body according to a third aspect, in the first or second aspect, each of the first workpiece and the second workpiece may made of any one of iron, copper, and aluminum.

In a joined body according to a fourth aspect, in the third aspect, a concentration of copper in the first joint may be less than or equal to 15 atom % when the first workpiece is made of iron and the second workpiece is made of copper.

In a joined body according to a fifth aspect, in the third aspect, a concentration of iron in the first joint may be less than or equal to 20 atom % when the first workpiece is made of copper and the second workpiece is made of iron.

In a joined body according to a sixth aspect, in the third aspect, a concentration of aluminum in the first joint may be less than or equal to 65 atom % when the first workpiece is made of iron and the second workpiece is made of aluminum.

In a joined body according to a seventh aspect, in the third aspect, a concentration of iron in the first joint may be less than or equal to 24 atom % when the first workpiece is made of aluminum and the second workpiece is made of iron.

In a joined body according to an eighth aspect, in the third aspect, a concentration of iron in the first joint may be less than or equal to 15 atom % when the first workpiece is made of copper and the second workpiece is made of iron.

In a joined body according to a ninth aspect, in the third aspect, a concentration of aluminum in the first joint may be less than or equal to 65 atom % when the first workpiece is made of iron and the second workpiece is made of aluminum.

In a joined body according to a tenth aspect, in the third aspect, a concentration of iron in the first joint may be less than or equal to 20 atom % when the first workpiece is made of copper and the second workpiece is made of aluminum.

In a joined body according to an eleventh aspect, in the third aspect, a concentration of copper in the first joint may be less than or equal to 30 atom % when the first workpiece is made of aluminum and the second workpiece is made of copper.

A laser machining method according to a twelfth aspect is a laser machining method for joining a first member containing a first metal and a second member containing a second metal different from the first metal, the method including a first step of forming a joint in which the first metal and the second metal are melted by performing scanning with a first laser beam, and a second step of stirring a metal structure near the joint by performing scanning, on a rear side in a scanning direction of the first laser beam, with a second laser beam having a beam diameter larger than a bean diameter of the first laser beam and having a lower power density than a power density of the first laser beam.

In a laser machining method according to a thirteenth aspect, in the twelfth aspect, the beam diameter of the second laser beam may be more than or equal to twice and less than or equal to three times the beam diameter of the first laser beam.

In a laser machining method according to a fourteenth aspect, in the twelfth or thirteenth aspect, the first laser beam and the second laser beam may be branched from a single laser beam into a plurality of beams in the scanning direction, and a beam-to-beam distance of adjacent laser beams among the laser beams branched into the plurality of beams may be more than or equal to twice a beam diameter of a laser beam on a front side in the scanning direction among the adjacent laser beams and less than or equal to twice a beam diameter of a laser beam on a rear side in the scanning direction among the adjacent laser beams.

In a laser machining method according to a fifteenth aspect, in the fourteenth aspect, the second laser beam may be branched from a bean from an output source into a plurality of beams by an optical system.

In a laser machining method according to a sixteenth aspect, in the fourteenth aspect, the second laser beam may be branched from a bean from an output source into a plurality of beams by a diffraction grating.

In a laser machining method according to a seventeenth aspect, in any one of the twelfth to sixteenth aspect, the second laser beam may have a wavelength of 266 nm to 11 μm.

A laser machining device according to an eighteenth aspect includes an irradiation optical system that irradiates a workpiece with a first laser beam on a front side along a scanning direction and a second laser beam on a rear side, and a scanning system that scans the workpiece with the first laser beam and the second laser beam along the scanning direction while irradiating the workpiece with the first laser beam and the second laser beam.

In a laser machining device according a nineteenth aspect, in the eighteenth aspect, the irradiation optical system may include a laser oscillator that emits a single laser beam, and a branching optical system that causes the single laser beam emitted from the laser oscillator to branch into a first laser beam and a second laser beam and irradiates a workpiece with the first laser beam and the second laser beam along the scanning direction.

Hereinafter, an exemplary embodiment of the present disclosure will be described in detail with reference to the drawings. The present disclosure is not limited to the following exemplary embodiments. Modifications can be made as appropriate without departing from the scope within which an effect of the present disclosure is exhibited.

Combinations with other exemplary embodiments are also possible.

The dissimilar metal material welding method according to the present disclosure can be applied to lap welding using a combination of plate materials of metal materials often used in the industry, such as iron, copper, and aluminum.

### First Exemplary Embodiment

### <Laser Machining Device>

A configuration of a laser machining device according to a first exemplary embodiment will be described.

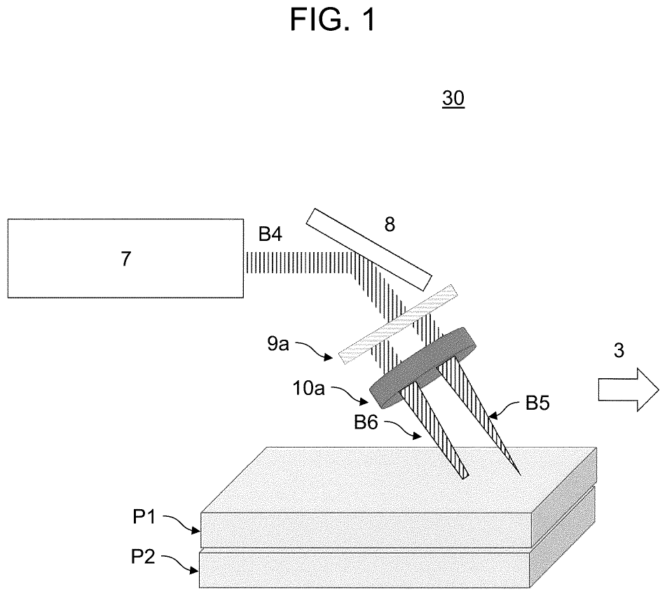

FIG. 1 is a schematic perspective view illustrating a configuration of an optical system using laser oscillator 7 and two-dimensional diffractive optical element 9a as a branching optical system in laser machining device 30 according to the first exemplary embodiment.

Laser machining device 30 includes irradiation optical systems 7, 8, 9a, 10a that irradiate workpieces P1, P2 with first laser beam B5 on the front side along scanning direction 3 and second laser beam B6 on the rear side, and a scanning system (not illustrated) that scans workpieces P1, P2 along scanning direction 3 while irradiating workpieces P1, P2 with first laser beam B5 and second laser beam B6. The irradiation optical system includes laser oscillator 7 that emits single laser beam B4, and branching optical systems 8, 9a, 10a that cause single laser beam B4 to branch into first laser beam B5 and second laser beam B6 and irradiate workpieces P1, P2 with the beams along scanning direction 3.

### <Workpiece>

A first metal that is the material of workpiece P1 is iron, having a thickness of 0.3 mm, a laser absorptivity of 40% at a wavelength λ of 1070 nm, and a melting point of 1700 K. The second metal that is the material of workpiece P2 is copper, having a thickness of 0.1 mm, a laser absorptivity of 5% at a wavelength λ of 1070 nm, and a melting point of 1300 K. At the time of laser machining, workpiece P1 and workpiece P2 are overlapped and fixed, and a fixing member is not illustrated.

### <Irradiation Optical System>

Laser oscillator 7 is a continuous oscillation single mode fiber laser of a wavelength of 1070 nm. Laser beam B4 is substantially parallel light of beam emitted by the laser oscillator 7.

Folding mirror 8 reflects more than or equal to 90% of light having a wavelength of 1070 nm. Two-dimensional diffractive optical element 9a transmits more than or equal to 90% of light having a wavelength of 1070 nm. The parallel light incident on two-dimensional diffractive optical element 9a can be transmitted through a lens to form a branched beam at the focal position of the lens. The number of branched beams, the branching interval, and the intensity ratio can be freely set by changing the pattern of two-dimensional diffractive optical element 9a. The corresponding wavelength of f-θ lens 10 is 1070 nm, the focal length is 255 mm, and the scanning range is 200 mm×200 mm. Folding mirror 8, two-dimensional diffractive optical element 9a, and f-θ lens 10 correspond to the branching optical system.

### <Operation of Two-Dimensional Diffractive Optical Element>

Next, an operation of two-dimensional diffractive optical element 9a will be described.

Laser beam B4 emitted from laser oscillator 7 is bent at an angle of 45° to scanning direction 3 side with respect to the vertical direction by folding mirror 8, and is branched into first laser beam B5 and second laser beam B6 by being transmitted through two-dimensional diffractive optical element 9a and f-θ lens 10a. The focal position of first laser beam B5 emitted at an angle of 45° toward scanning direction 3 side with respect to the vertical direction is set to be on a surface of workpiece P1. Thus, the irradiation diameter on workpiece P1 of second laser beam B6 on the rear side with respect to scanning direction 3 is larger than that of first laser beam B5 on the front side with respect to the scanning direction due to the inclination of the irradiation angle.

### <Scanning System>

The scanning system (not illustrated) scans workpieces P1, P2 along scanning direction 3 while irradiating workpieces P1, P2 with first laser beam B5 and second laser beam B6. The scanning system is not limited as long as it moves the irradiation optical system and the workpiece relative to each other. For example, at least a part of the irradiation optical system may be moved along scanning direction 3. Alternatively, workpieces P1, P2 may be moved in the direction opposite to scanning direction 3 with respect to the irradiation optical system. Scanning direction 3 is not limited to a linear direction, and may be a curved direction, for example, an arc. The scanning system may be a commonly used driver.

Since the irradiation and the scanning of first and second laser beams B5, B6 are performed at the same time, “irradiation” may be omitted as “scanning” includes “irradiation” for the sake of convenience other than the case where the scanning and the irradiation are separately described.

### First Modified Example

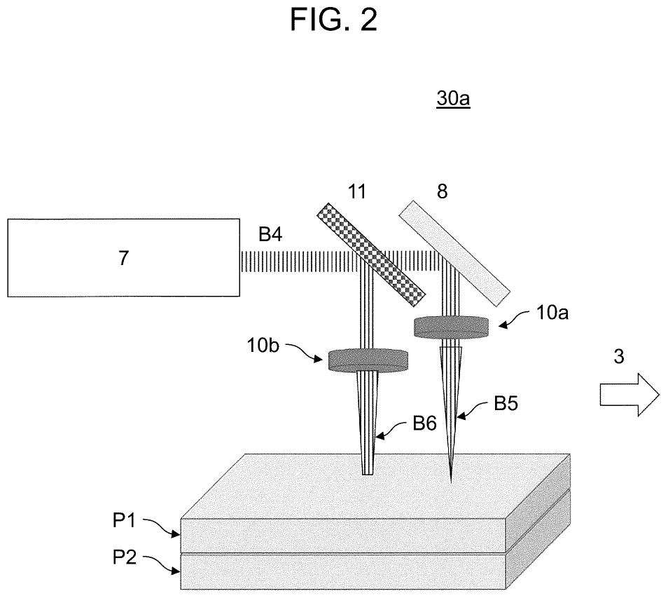

FIG. 2 is a schematic perspective view illustrating a configuration using laser oscillator 7 and branching optical systems 8, 11, 10a, 10b in laser machining device 30a according to a first modified example of the first exemplary embodiment.

Like the configuration using the two-dimensional diffractive optical element of FIG. 1, laser beam B4 is emitted from laser oscillator 7, and laser beam B4 is branched at the same ratio by half mirror 11. Two-branched first and second laser beams B5, B6 are condensed on workpiece P1 by two f-θ lenses. At this time, f-θ lens 10a that condenses first laser beam B5 on the front side in scanning direction 3 and f-θ lens 10b that condenses second laser beam B6 on the rear side have the same focal length. Thus, when the beam diameters are different from each other, the beam diameter of second laser beam B6 can be made larger than the beam diameter of first laser beam B5 by shifting the lens arrangement position in a height direction. The focal length of f-θ lens 10b that condenses second laser beam B6 may be different from the focal length of the f-θ lens that condenses first laser beam B5.

### Second Modified Example

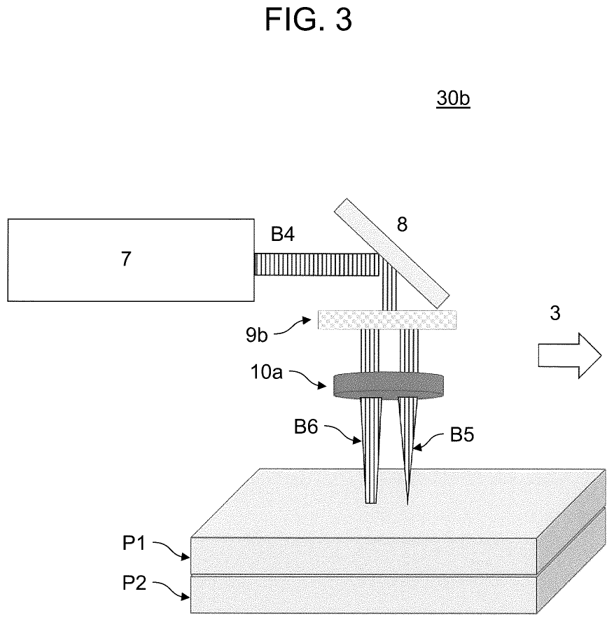

FIG. 3 is a schematic perspective view illustrating a configuration of an optical system using laser oscillator 7 and three-dimensional diffractive optical element 9b as a branching optical system in laser machining device 30b according to a second modified example of the first exemplary embodiment. In three-dimensional diffractive optical element 9b, unlike two-dimensional diffractive optical element 9a, the focal diameter is not determined by the focal plane after light is transmitted through the lens, but the focal intention of the branched beams can be changed in an optical axis direction.

This eliminates restrictions on the device configuration such as interference between f-θ lens 10a and f-θ lens 10b of the configuration of FIG. 2. In addition, the folding angle of the laser with folding mirror 8 is set to 90° incidence typically used in laser machining, the beam diameters of first laser beam B5 and second laser beam B6 can be set to any diameters without adjusting the angle of the mirror to 45°, and beam-to-beam distance L15 can be set to any beam-to-beam distance.

The wavelength of the laser beam emitted from laser oscillator 7 illustrated in FIGS. 1 to 3 of the present disclosure may be in the range from 266 nm to 11 μm inclusive where laser welding is possible.

Although the mirror angle is 45° in FIG. 2, another angle may be used as long as a difference in focal diameter between first laser beam B5 and second laser beam B6 can be made.

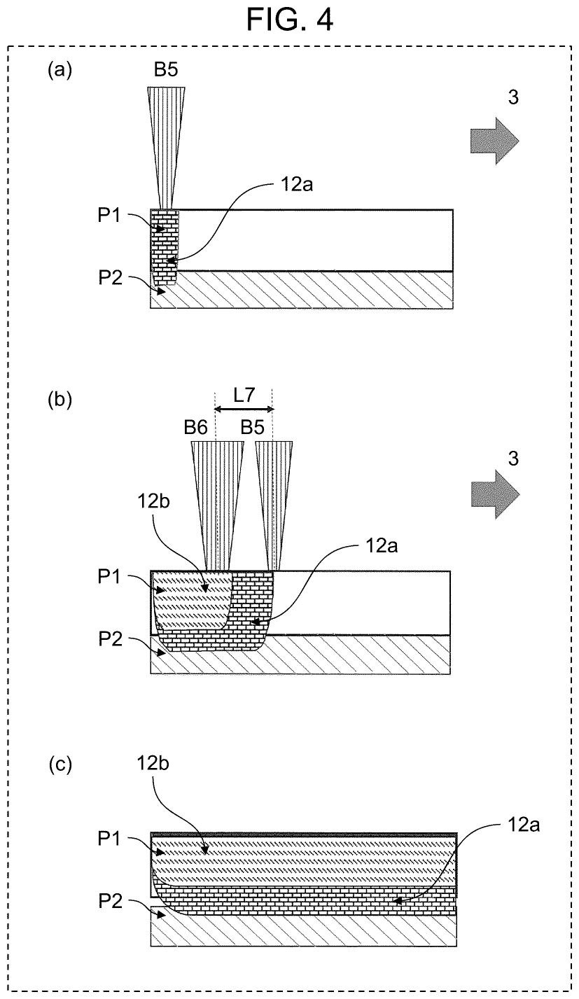

FIG. 4 is a schematic sectional view illustrating the states of a section of a molten part in time series in the order of (a), (b), and (c) when sequential scanning with first laser beam B5 and second laser beam B6 is performed on workpiece P1 and workpiece P2 overlapping each other in the laser machining method according to the first exemplary embodiment.

First molten part 12a is a portion melted through incidence of first laser beam B5. Second molten part 12b is a portion melted by second laser beam B6 branched rearward from first laser beam B5. Beam-to-beam distance L15 is a center-to-center distance between beams of first laser beam B5 and second laser beam B6 branched rearward.

The molten part formed in the laser machining method according to the first exemplary embodiment will be described in chronological order with reference to FIG. 4.

(1) As illustrated in part (a) of FIG. 4, first laser beam B5 is incident on a joint portion of dissimilar metal materials of workpiece P1 and workpiece P2, and scanning is performed in scanning direction 3. Workpiece P1 and workpiece P2 melt to form first molten part 12a.

(2) As illustrated in part (b) of FIG. 4, scanning with second laser beam B6 branched rearward from first laser beam B5 forms second molten part 12b that penetrates into the vicinity of the joint inside workpiece P1.

At this time, it is necessary that the penetration depth of second molten part 12b does not penetrate workpiece P1 and does not reach workpiece P2, and an ideal stirring effect can be obtained when penetration is formed to a depth of 80% to 95% of the thickness of workpiece P1.

(3) As illustrated in part (c) of FIG. 4, scanning with first laser beam B5 and second laser beam B6 is performed in scanning direction 3, and both first laser beam B5 and second laser beam B6 scan workpieces P1, P2 so as to run through to the ends of workpieces P1, P2, whereby a joined body is obtained.

At this time, there is a relationship of penetration depth of first molten part 12a≤thickness of workpiece P1≤penetration depth of second molten part 12b≤thickness of workpiece P1+workpiece P2. In this manner, the joined body illustrated in part (c) of FIG. 4 includes workpiece P1 (an example of a first workpiece), workpiece P2 (an example of a second workpiece), first molten part 12a (an example of a first joint), and second molten part 12b (an example of a second joint). Here, first molten part 12a and second molten part 12b are examples of joints that join workpiece P1 and workpiece P2.

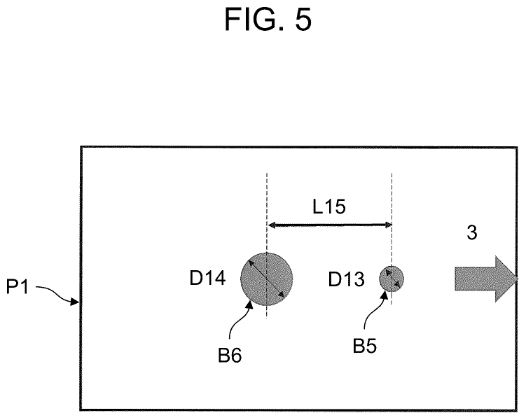

FIG. 5 is a plan view illustrating beam diameters D13, D14 and beam-to-beam distance L15 of first laser beam B5 and second laser beam B6 with which workpiece P1 is irradiated in the laser machining method according to the first exemplary embodiment.

The beam diameter of first laser beam B5 on the front side in scanning direction 3 is D13, and the beam diameter of second laser beam B6 branched rearward is D14. The beam-to-beam distance between first laser beam B5 and second laser beam B6 is L15.

First laser beam B5 and second laser beam B6 with which a surface of workpiece P1 is irradiated perform scanning at the same speed in scanning direction 3 with beam-to-beam distance L15. Second laser beam B6 branched rearward has a larger condensing diameter at the machining point than first laser beam B5. When beam diameter D14 is small, the volume of the molten pool to be stirred is small, and the molten pool is not sufficiently stirred. Conversely, when beam diameter D14 is too large, a large keyhole in which first laser beam B5 and second laser beam B6 are integrated is formed, and a target stirring effect cannot be obtained. Thus, to control the composition of the molten part and sufficiently stir the molten part, beam diameter D14 is desirably more than or equal to twice and less than or equal to three times beam diameter D13.

When beam-to-beam distance L15 is too small, first laser beam B5 and second laser beam B6 become a large keyhole integrated with each other, and a target stirring effect cannot be obtained. When the beam-to-beam distance is too wide, the solidification of first molten part 12a melted by first laser beam B5 progresses, the convection of the portion scanned with second laser beam B6 is not promoted, and a sufficient stirring effect cannot be obtained. Thus, a sufficient stirring effect can be obtained by setting beam-to-beam distance L15 to a distance of more than or equal to twice beam diameter D13 and less than or equal to twice beam diameter D14.

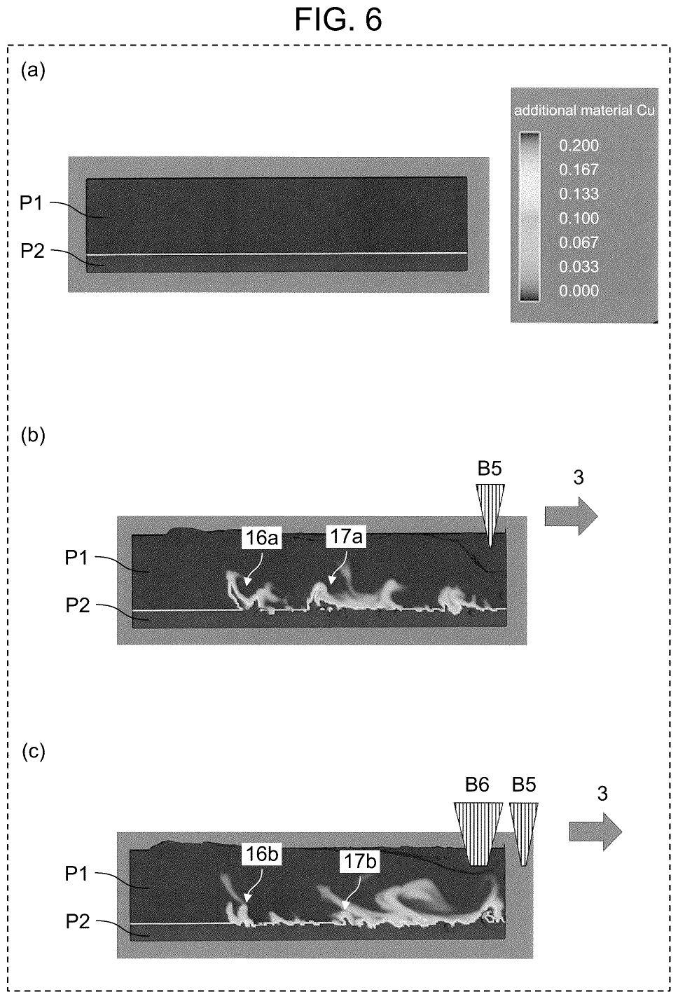

FIG. 6 includes schematic diagrams illustrating the proportion of the Cu element in a section after laser beam scanning divided by the number of laser scans in (a) to (c) in a simulation of laser welding of overlapping members of Fe and Cu in the laser machining method according to the first exemplary embodiment.

Part (a) of FIG. 6 is a schematic diagram illustrating a model before laser irradiation. The thick rectangular member in the upper part of the model indicates Fe of workpiece P1, and the thin rectangular member in the lower part of the model is Cu of workpiece P2.

Part (b) of FIG. 6 is a schematic diagram illustrating the concentration of Cu in a section after workpiece P1 and workpiece P2 are joined by scanning only with first laser beam B5. In the normal lap welding using one laser beam, many regions where the concentration of Cu exceeds 15 atom % and solidification cracking occurs, such as regions 16a and 17a, exist inside workpiece P1 made of Fe.

Part (c) of FIG. 6 is a sectional view when scanning with second laser beam B6 branched rearward is performed after scanning with first laser beam B5 is performed. As a result of stirring the vicinity of the joint with second laser beam B6, in regions 16b, 17b at the same places as regions 16a, 17a where the concentration of Cu exceeds 15 atom % in part (b) of FIG. 6, the concentration of Cu can be greatly reduced to less than or equal to 10 atom % at which solidification cracking does not occur.

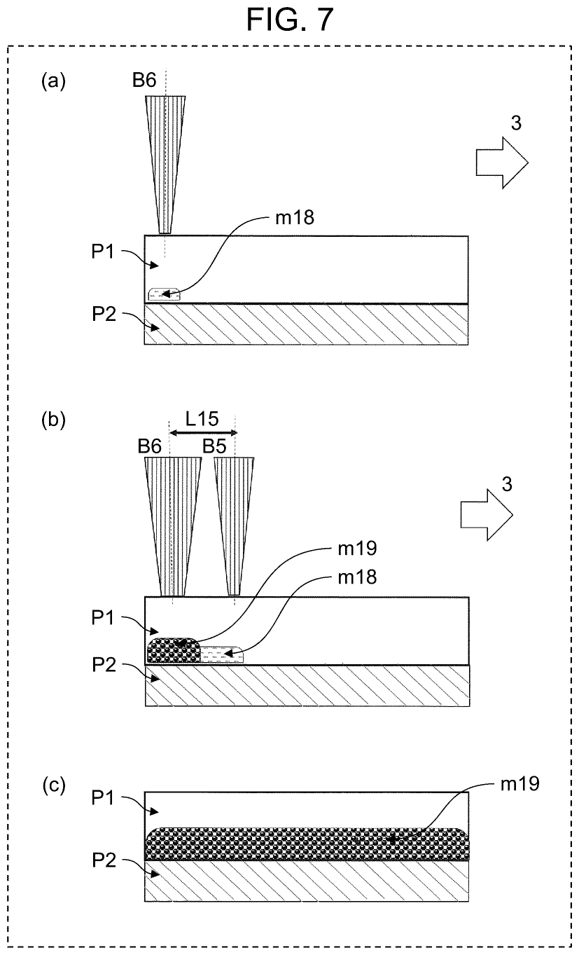

FIG. 7 is a schematic diagram illustrating, in time series in the order of (a), (b), and (c), the states of mixing and stirring of dissimilar metals in the vicinity of the joining interface between workpiece P1 and workpiece P2 when workpiece P1 and workpiece P2 are overlapped and scanned with first laser beam B5 and second laser beam B6 in the laser machining method according to the first exemplary embodiment.

Description will be made in chronological order.

a) In part (a) of FIG. 7, first laser beam B5 is applied to the dissimilar metal materials of workpiece P1 and workpiece P2 overlapping each other, and region m18 of a dissimilar metal mixed layer of workpiece P1 and workpiece P2 is formed above the joint of workpiece P1 and workpiece P2. In region m18 of the dissimilar metal mixed layer, there is a portion where the proportion of the metal constituting workpiece P2 is more than or equal to several 10 atom % as in part (b) of FIG. 6 described above.

b) Part (b) of FIG. 7 illustrates a state in which second laser beam B6 branched rearward from first laser beam B5 is emitted, and second laser beam B6 penetrates into the vicinity of the interface between workpiece P1 and workpiece P2 to perform scanning. Since second laser beam B6 is about two to three times larger than the beam diameter of first laser beam B5 used for joining, the convection is promoted by scanning with this beam, and the metal element constituting workpiece P2 in region m18 is stirred in a wide range inside workpiece P1. Scanning with second laser beam B6 is performed along scanning direction 3.

c) As illustrated in part (c) of FIG. 7, the metal element constituting workpiece P2 is stirred over a wide range including region m18, and region m19 of the dissimilar metal mixed layer in which the proportion of the metal element constituting workpiece P2 is reduced from that in region m18 is formed.

In part (c) of FIG. 7, the joining of the overlapping members of workpiece P1 and workpiece P2 with first laser beam B5 and second laser beam B6 branched rearward reach the ends of workpiece P1 and workpiece P2, and region m19 in which region m18 of the dissimilar metal mixed layer is entirely filled is formed up to the member ends.

### (Welding Defect)

As described in the problems, for example, in the case of joining workpiece P1 made of Fe and workpiece P2 made of Cu, solidification cracking occurs as a defect of dissimilar metal joining. In addition, in joining Fe and Al or Cu and Al of other metals, joint strength is reduced due to formation of an intermetallic compound. The dominant factor is considered to be the influence caused by the proportions of atoms of the dissimilar metal materials contained in regions m18, m19 of the dissimilar metal mixed layer in the vicinity of the joint falling in a specific range when workpiece P1 and workpiece P2 are joined. In the laser machining method according to the present disclosure, the proportions of region m18, region m19 are controlled as follows from the viewpoint of suppressing solidification cracking and suppressing formation of an intermetallic compound layer.

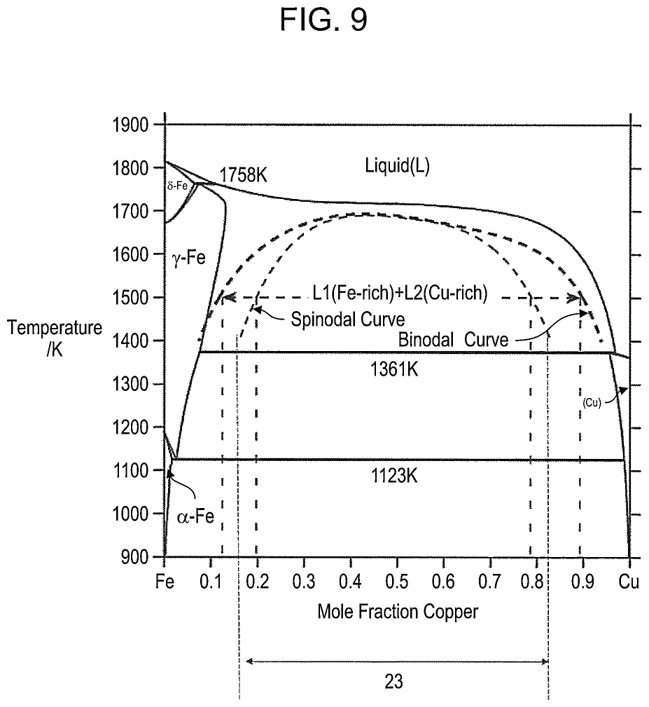

When workpiece P1 is Fe and workpiece P2 is Cu, the proportion of Cu in region m19 is controlled to less than or equal to 15 atom % so as not to fall in region 23 in the equilibrium state diagram illustrated in FIG. 9 using the method of the present disclosure. On the other hand, when workpiece P1 is Cu and workpiece P2 is Fe, solidification cracking does not occur and a good solid solution is formed by setting the proportion of Cu in region m19 to more than or equal to 90 atom %.

### (Suppression of Formation of Intermetallic Compound Layer)

(1) When the combination of workpiece P1 and workpiece P2 is Al and Cu, the overlapping members are joined by laser scanning, and regions m18, m19 of the dissimilar metal mixed layer in the vicinity of the joint become a mixed layer of Al and Cu. From the equilibrium state diagram of Al and Cu in FIG. 11, when the proportion of Cu reaches the region of 52.5 atom % to 90 atom % in regions m18, m19 of the mixed layer of dissimilar metals of Al and Cu, CuAl₂ which is an intermetallic compound is formed.

(2) When the combination of workpiece P1 and workpiece P2 is Fe and Al, M1 in the vicinity of the welded joint becomes a mixed layer of Fe and Al in the same manner. An aluminum-rich intermetallic compound such as FeAl₂ is formed when the proportion of Al shown in region 24 of the equilibrium state diagram of Fe-Al in FIG. 10 falls in the region from 65 atom % to less than or equal to 67 atom %, Fe₂Al₅ is formed when the proportion falls in the region of from 71 atom % to 73 atom %, and FeAl₃ is formed when the proportion is 76 atom %.

These intermetallic compounds have hard and brittle mechanical properties as compared with a simple substance of Cu, Al, or Fe, and thus, when a load is generated, these intermetallic compounds are likely to be a starting point of cracks and cause a decrease in strength of a welded joint.

It is possible to suppress formation of an intermetallic compound layer by stirring mixed region m18 in a wider range with second laser beam B6 branched from first laser beam B5 used for joining, and forming a region of a mixed layer of dissimilar metals such as region m19 in which the mixing proportion of Al, Cu, Fe, or Al is reduced by using the method of the present disclosure.

Workpiece P1 and workpiece P2 on the laser irradiation side in the present disclosure illustrated in FIG. 1 and subsequent drawings are plate materials mainly made of iron, copper, and aluminum, and the effect is exhibited even when plating processing of Ni or like of about several m is performed.

### (Multi-Branching Irradiation)

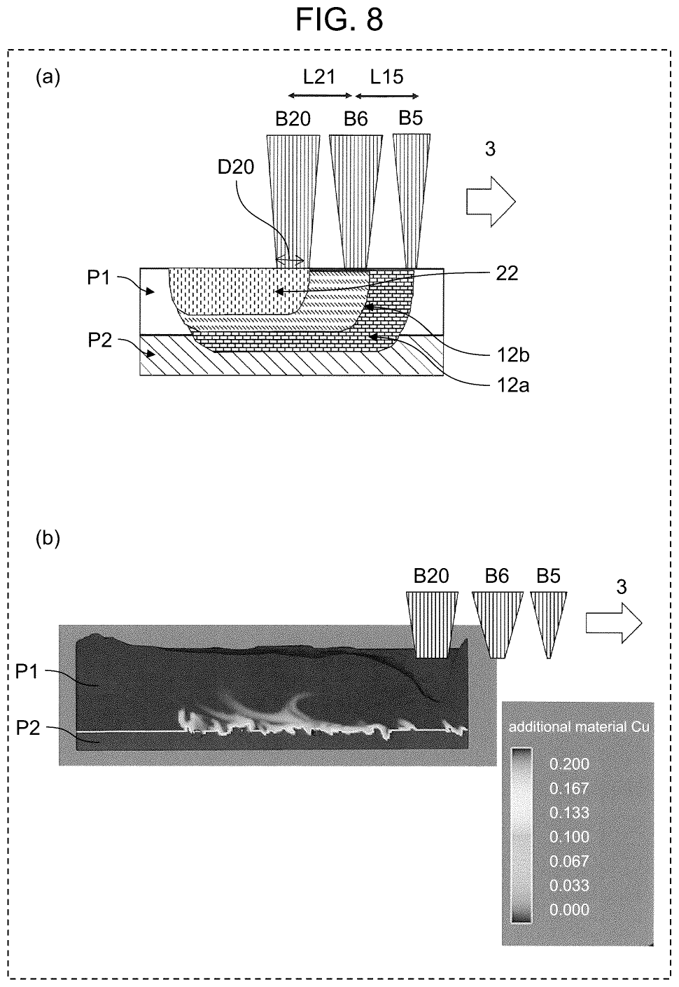

In the present invention, scanning with second laser beam B6 is performed from the rear side for the purpose of stirring the molten part on the rear side of first laser beam B5 for joining, but there is a case where the dissimilar metal mixing part of the molten part cannot be sufficiently stirred by this one-time stirring. In such a case, as illustrated in FIG. 8, the molten part once stirred may be stirred again by performing scanning with third laser beam B20 branched further rearward.

Part (a) of FIG. 8 is a schematic sectional view illustrating third molten part 22 after being further stirred by scanning with three beams including third laser beam B20 branched further rearward from second laser beam B6 branched rearward with respect to region m18 of the dissimilar metal mixed layer formed by scanning with second laser beam B6. In third molten part 22, second molten part 12b once stirred by second laser beam B6 is stirred again by third laser beam B20.

At this time, third molten part 22 penetrates to a depth of 80% to 95% of the penetration depth of second molten part 12b, and thus an effect of stirring a wide range can be obtained.

Part (b) of FIG. 8 is a simulation result when the molten part once stirred is stirred again by scanning with the third laser beam from the rear side as described above.

In the simulation result in part (b) of FIG. 8, it is confirmed that the concentration of Cu through two-time stirring scanning is lower in the entire region than the concentration of Cu in the entire dissimilar metal mixed region through the single stirring scanning in the exemplary embodiment illustrated in part (c) of FIG. 6, and it is found that a favorable joint is formed.

### (Exemplary Embodiment of Three-Branched Stirring Scanning)

The condensing diameter (beam diameter D20) at a machining point diameter of third laser beam B20 branched rearward is preferably larger than those of first laser beam B5 and second laser beam B6. In addition, from the simulation result, in order to obtain a stirring effect in a wide range while controlling the composition of the molten part, beam diameter D20 is desirably more than or equal to twice and less than or equal to three times beam diameter D14 of second laser beam B6.

As for beam-to-beam distance L21, from the simulation, when beam-to-beam distance L21 is too small, second laser beam B6 and third laser beam B20 are integrated into a large keyhole, and a target stirring effect cannot be obtained. When the beam-to-beam distance is too wide, the convection of the portion where scanning with the laser of third laser beam B20 is performed is not promoted, and a sufficient stirring effect cannot be obtained. Thus, a sufficient stirring effect can be obtained by setting beam-to-beam distance L21 to a distance substantially equal to beam-to-beam distance L15.

The present disclosure includes an appropriate combination of any exemplary embodiment or example among the various above-described exemplary embodiments or examples, and effects of each of the exemplary embodiments or examples can be achieved.

### INDUSTRIAL APPLICABILITY

According to the laser machining method and the laser machining device of the present disclosure, irradiation and scanning with the first laser beam on the front side, followed by irradiation and scanning with the second laser beam on the rear side, are performed to join the overlapping members. With this configuration, the metal structure in the vicinity of the joint is stirred by irradiation with the second laser beam, and the concentration of the dissimilar metal material in the joint is reduced, which makes it possible to produce a joined body that prevents solidification cracking and formation of an intermetallic compound. Therefore, it is useful for joining dissimilar metal materials.

### REFERENCE MARKS IN THE DRAWINGS

3: scanning direction
7: laser oscillator
8: folding mirror
9a, 9b: two-dimensional diffractive optical element
10, 10a: f-θ lens
11: half mirror
12a: first molten part
12b: second molten part
22: third molten part
23: region
24: region
25: region
26: can
27: negative electrode tab
28: molten part
29: re-molten part
30, 30a, 30b: laser machining device
P1: workpiece
P2: workpiece
B4: laser beam
B5: first laser beam
B6: second laser beam
B20: third laser beam
D13: beam diameter
D14: beam diameter
D20: beam diameter

1. A joined body comprising:
a first workpiece made of a first metal;
a second workpiece made of a second metal different from the first metal; and
a joint joining the first workpiece and the second workpiece,
wherein the joint includes a first joint located on a side of the first workpiece and a second joint located on a side of the second workpiece, and
a concentration of metal contained in the first joint is different from a concentration of metal contained in the second joint.

2. The joined body according to claim 1, wherein the first joint has a thickness larger than a thickness of the second joint in a sectional view in a direction perpendicular to a direction of overlapping of the first workpiece and the second workpiece.

3. The joined body according to claim 1, wherein each of the first workpiece and the second workpiece is made of any one of iron, copper, and aluminum.

4. The joined body according to claim 3, wherein
the first workpiece is made of iron,
the second workpiece is made of copper, and
a concentration of copper in the first joint is less than or equal to 15 atom %.

5. The joined body according to claim 3, wherein
the first workpiece is made of copper,
the second workpiece is made of iron, and
a concentration of iron in the first joint is less than or equal to 20 atom %.

6. The joined body according to claim 3, wherein
the first workpiece is made of iron,
the second workpiece is made of aluminum, and
a concentration of aluminum in the first joint is less than or equal to 65 atom %.

7. The joined body according to claim 3, wherein
the first workpiece is made of aluminum,
the second workpiece is made of iron, and
a concentration of iron in the first joint is less than or equal to 24 atom %.

8. The joined body according to claim 3, wherein
the first workpiece is made of copper,
the second workpiece is made of iron, and
a concentration of iron in the first joint is less than or equal to 15 atom %.

9. The joined body according to claim 3, wherein
the first workpiece is made of iron,
the second workpiece is made of aluminum, and
a concentration of aluminum in the first joint is less than or equal to 65 atom %.

10. The joined body according to claim 3, wherein
the first workpiece is made of copper,
the second workpiece is made of aluminum, and
a concentration of iron in the first joint is less than or equal to 20 atom %.

11. The joined body according to claim 3, wherein
the first workpiece is made of aluminum,
the second workpiece is made of copper, and
a concentration of copper in the first joint is less than or equal to 30 atom %.

12. A laser machining method for joining a first member containing a first metal and a second member containing a second metal different from the first metal, the method comprising:
a first step of forming a joint in which the first metal and the second metal are melted by performing scanning with a first laser beam; and
a second step of stirring a metal structure near the joint by performing scanning, on a rear side in a scanning direction of the first laser beam, with a second laser beam having a beam diameter larger than a bean diameter of the first laser beam and having a lower power density than a power density of the first laser beam.

13. The laser machining method according to claim 12, wherein the beam diameter of the second laser beam is more than or equal to twice and less than or equal to three times the beam diameter of the first laser beam.

14. The laser machining method according to claim 12, wherein
the first laser beam and the second laser beam are branched from a single laser beam into a plurality of beams in the scanning direction, and
a beam-to-beam distance of adjacent laser beams among the laser beams branched into the plurality of beams is more than or equal to twice a beam diameter of a laser beam on a front side in the scanning direction among the adjacent laser beams and less than or equal to twice a beam diameter of a laser beam on a rear side in the scanning direction among the adjacent laser beams.

15. The laser machining method according to claim 14, wherein the second laser beam is branched from a bean from an output source into a plurality of beams by an optical system.

16. The laser machining method according to claim 14, wherein the second laser beam is branched from a bean from an output source into a plurality of beams by a diffraction grating.

17. The laser machining method according to claim 12, wherein the second laser beam has a wavelength of 266 nm to 11 μm.

18. A laser machining device comprising:
an irradiation optical system that irradiates a workpiece with a first laser beam on a front side along a scanning direction and a second laser beam on a rear side; and
a scanning system that scans the workpiece with the first laser beam and the second laser beam along the scanning direction while irradiating the workpiece with the first laser beam and the second laser beam.

19. The laser machining device according to claim 18, wherein the irradiation optical system includes
a laser oscillator that emits a single laser beam, and
a branching optical system that causes the single laser beam emitted from the laser oscillator to branch into a first laser beam and a second laser beam and irradiates a workpiece with the first laser beam and the second laser beam along the scanning direction.
